(19) United States
(12) Patent Application Publication
(10) Pub. No.: US 2025/0266477 A1
(43) Pub. Date: Aug. 21, 2025

(54) FUEL CELL VEHICLE, METHOD OF REFRESHING THE SAME, AND RECORDING MEDIUM STORING PROGRAM TO EXECUTE THE METHOD

(71) Applicants: Hyungdai Motor Company, Seoul (KR); Kia Corporation, Seoul (KR)

(72) Inventor: Tae Woo RYU, Seoul (KR)

(73) Assignees: Hyundai Motor Company, Seoul (KR); Kia Corporation, Seoul (KR)

(21) Appl. No.: 18/816,974

(22) Filed: Aug. 27, 2024

(30) Foreign Application Priority Data
Feb. 16, 2024 (KR) 10-2024-0022532

(51) Int. Cl. H01M 8/04537; B60L 50/75; H01M 8/04858

(52) U.S. Cl. CPC H01M 8/04567; B60L 50/75; H01M 8/04888

(57) ABSTRACT

A fuel cell vehicle includes a battery, a cell stack configured to generate and output a stack voltage, a converter configured to boost the voltage of the battery, a load configured to be driven by the stack voltage and the boosted voltage of the battery, and a refresh unit connected to the battery and the cell stack and configured to adjust a refresh voltage at which to refresh a catalyst of the cell stack depending on the state of charge of the battery.

### CROSS-REFERENCE TO RELATED APPLICATION

The present application claims priority to Korean Patent Application No. 10-2024-0022532, filed on Feb. 16, 2024, the entire contents of which is incorporated herein for all purposes by this reference.

### BACKGROUND OF THE PRESENT DISCLOSURE

### Field of the Present Disclosure

The present disclosure relates to a fuel cell vehicle, a method of refreshing the same, and a recording medium storing a program to execute the method.

### DESCRIPTION OF RELATED ART

A cell stack of a fuel cell mounted in a fuel cell vehicle may supply power, generated through electrochemical reaction between air supplied to one surface of a polymer electrolyte membrane and hydrogen supplied to the opposite surface of the polymer electrolyte membrane, to an external load. If a fuel cell vehicle is exposed to a medium potential or a high potential during travel, an oxide film, which causes reversible performance deterioration, may be formed on a cell stack. It is necessary to implement low-potential driving to remove the oxide film, and catalyst refresh control needs to be performed to implement low-potential driving in a vehicle.

FIG. 1A and FIG. 1B are diagrams for explaining catalyst refresh.

FIG. 1A shows oxidation 1 from a left catalyst to a right catalyst and reduction 2 from the right oxidized catalyst to the left catalyst. In FIG. 1B, the horizontal axis indicates current density, and the vertical axis indicates a cell voltage.

Referring to FIG. 1A and FIG. 1B, if a vehicle is normally driven in a low-output and high-potential (e.g., 0.7 volts or higher) mode (indicated by reference numeral 10), a reversible oxide may be formed on the surface of the chemical catalyst (Pt) through electrochemical reaction. Due to the present oxide, the effective area of an electrode may be reduced, and thus current-voltage performance of a cell may deteriorate.

The reversible oxide may be removed when the potential of a cell stack is low. Therefore, the vehicle may be periodically driven in a high-output and low-potential (e.g., 0.7 volts or lower) mode (indicated by reference numeral 20) to momentarily lower a stack voltage (indicated by reference numeral 30). In the present way, catalyst refresh control (hereinafter referred to as “catalyst refresh”), which removes the reversible oxide from the catalyst to reduce the catalyst, may be performed to improve the performance of the cell stack. The higher the output of the cell stack, the lower the voltage thereof. However, because a driver does not always drive the vehicle in a high-output mode, catalyst refresh is periodically performed to lower the voltage. In the instant case, a battery may be charged with power momentarily generated due to oxygen remaining in the cell stack.

Catalyst refresh may cause damage to the vehicle. Therefore, research with the goal of solving the present problem is underway.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a fuel cell vehicle, a method of refreshing the same, and a recording medium storing a program to execute the method that substantially obviate one or more problems due to limitations and disadvantages of the related art.

Embodiments provide a fuel cell vehicle configured for performing refresh without damage thereto, a method of refreshing the same, and a recording medium storing a program to execute the method.

The objects to be accomplished by the exemplary embodiments are not limited to the above-mentioned objects, and other objects not mentioned herein will be clearly understood by those skilled in the art from the following description.

Additional advantages, objects, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure pointed out in the written description and claims hereof as well as the appended drawings.

A fuel cell vehicle according to various exemplary embodiments of the present disclosure may include a battery, a cell stack configured to generate and output a stack voltage, a converter configured to boost the voltage of the battery, a load configured to be driven by the stack voltage and the boosted voltage of the battery, and a refresh unit connected to the battery and the cell stack and configured to adjust a refresh voltage at which to refresh a catalyst of the cell stack depending on the state of charge of the battery.

In an exemplary embodiment of the present disclosure, the refresh unit may include a voltage calculation unit configured to determine an expected voltage of the battery expected when refreshing the cell stack and a voltage determination unit configured to compare a target voltage at which to refresh the cell stack with the expected voltage and to determine the refresh voltage based on a result of the comparison.

In an exemplary embodiment of the present disclosure, the cell stack may be maximally refreshed at the target voltage.

In an exemplary embodiment of the present disclosure, when determining the expected voltage, the voltage calculation unit may use an expected refresh power of the cell stack in which the degree of deterioration of the cell stack is reflected.

In an exemplary embodiment of the present disclosure, the expected refresh power may be obtained experimentally or may be determined in real time.

In an exemplary embodiment of the present disclosure, the fuel cell vehicle may further include a storage unit configured to store a zero-potential voltage of the battery and a resistance value of the battery for each state of charge of the battery.

In an exemplary embodiment of the present disclosure, the voltage calculation unit may read a zero-potential voltage and a resistance value corresponding to the state of charge from the storage unit and may use the zero-potential voltage and the resistance value to determine the expected voltage.

In an exemplary embodiment of the present disclosure, the voltage calculation unit may be configured to determine the expected voltage as follows.

$${V}_{b} = Vo - ( \frac{Vo - \sqrt{{Vo}^{2} - 4 \times R \times P}}{2 \times R} ) \times R$$

Here, Vb represents the expected voltage, Vo represents the read zero-potential voltage, R represents the read resistance value, and P represents the expected refresh power.

In an exemplary embodiment of the present disclosure, the voltage determination unit may include a comparison unit configured to compare the target voltage with the expected voltage and a voltage selection unit configured to output the target voltage or the expected voltage as the determined refresh voltage in response to a result of the comparison by the comparison unit.

In an exemplary embodiment of the present disclosure, the refresh unit may check whether the battery is in a fully-charged state and may adjust the refresh voltage in response to a result of the checking.

In an exemplary embodiment of the present disclosure, the fuel cell vehicle may further include a battery management unit configured to check the state of charge of the battery and to output a result of the checking to the refresh unit.

According to another exemplary embodiment of the present disclosure, a method of refreshing a fuel cell vehicle, which includes a battery, a cell stack configured to generate and output a stack voltage, and a converter configured to boost the voltage of the battery, may include checking whether refresh of a catalyst of the cell stack is required, and when refresh is required, adjusting a refresh voltage at which to refresh the catalyst of the cell stack depending on the state of charge of the battery.

In an exemplary embodiment of the present disclosure, the method may further include, when refresh is required, checking whether the battery is in a fully-charged state, and when the battery is not in a fully-charged state, the refresh voltage may be adjusted.

In an exemplary embodiment of the present disclosure, the adjusting may include, when refresh is required, determining an expected voltage of the battery expected when refreshing the cell stack, checking whether a target voltage at which to refresh the cell stack is higher than the determined expected voltage, when the target voltage is higher than the expected voltage, determining the target voltage to be an adjusted refresh voltage, and when the target voltage is lower than the expected voltage, determining the expected voltage to be an adjusted refresh voltage.

According to various exemplary embodiments of the present disclosure, a non-transitory computer-readable recording medium storing a program for executing a method of refreshing a fuel cell vehicle, which includes a battery, a cell stack configured to generate and output a stack voltage, and a converter configured to boost the voltage of the battery, may store a program to implement a function of checking whether refresh of a catalyst of the cell stack is required and a function of, when refresh is required, adjusting a refresh voltage at which to refresh the catalyst of the cell stack depending on the state of charge of the battery.

In an exemplary embodiment of the present disclosure, the program may further implement a function of, when refresh is required, checking whether the battery is in a fully-charged state, and when the battery is not in a fully-charged state, the program may adjust the refresh voltage.

In an exemplary embodiment of the present disclosure, the function of adjusting may include a function of, when refresh is required, determining an expected voltage of the battery expected when refreshing the cell stack, a function of checking whether a target voltage at which to refresh the cell stack is higher than the determined expected voltage, a function of, when the target voltage is higher than the expected voltage, determining the target voltage to be an adjusted refresh voltage, and a function of, when the target voltage is lower than the expected voltage, determining the expected voltage to be an adjusted refresh voltage.

It is to be understood that the foregoing general description and the following detailed description of the present disclosure are exemplary and explanatory and are intended to provide further explanation of the present disclosure as claimed.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A and FIG. 1B are diagrams for explaining catalyst refresh;

FIG. 2 is a block diagram of a fuel cell vehicle according to an exemplary embodiment of the present disclosure;

FIG. 3 is a block diagram of an exemplary embodiment of a refresh unit shown in FIG. 2;

FIG. 4 is a block diagram of an exemplary embodiment of a voltage determination unit shown in FIG. 3;

FIG. 5 is a flowchart for explaining a method of refreshing a fuel cell vehicle according to an exemplary embodiment of the present disclosure;

FIG. 6A and FIG. 6B are graphs for explaining a first application example of the refresh method according to the embodiment;

FIG. 7A and FIG. 7B are graphs for explaining a second application example of the refresh method according to the embodiment;

FIG. 8 is a block diagram of a fuel cell vehicle according to a comparative example;

FIG. 9A and FIG. 9B are graphs showing the normal voltage and output characteristics of the fuel cell vehicle according to the comparative example, respectively; and

FIG. 10A and FIG. 10B are graphs showing the abnormal voltage and output characteristics of the fuel cell vehicle according to the comparative example, respectively.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

The present disclosure will now be described more fully hereinafter with reference to the accompanying drawings, in which various exemplary embodiments of the present disclosure are shown. The examples, however, may be embodied in many different forms, and should not be construed as being limited to the embodiments set forth herein. Rather, these embodiments are provided so that the present disclosure will be more thorough and complete, and will more fully convey the scope of the present disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

Furthermore, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

Hereinafter, a fuel cell vehicle (hereinafter referred to as a “vehicle”) 100 according to an exemplary embodiment will be described with reference to the accompanying drawings.

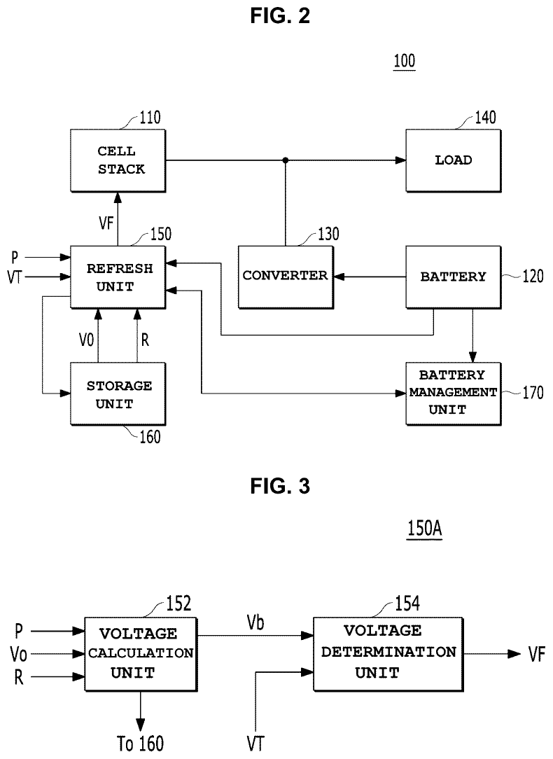

FIG. 2 is a block diagram of the fuel cell vehicle 100 according to an exemplary embodiment of the present disclosure. The vehicle 100 may include a cell stack 110, a battery 120, a converter 130, a load 140, and a refresh unit 150. Furthermore, the vehicle 100 may further include a storage unit 160. Furthermore, the vehicle 100 may further include a battery management unit 170 including a processor. Furthermore, the vehicle 100 according to the exemplary embodiment of the present disclosure may further include a peripheral auxiliary device (balance-of-plant (BOP)).

First, an example of a fuel cell which may be included in the vehicle 100 will be described below in brief. However, the exemplary embodiments are not limited to any specific form of fuel cell included in the vehicle 100.

The fuel cell may be, for example, a polymer electrolyte membrane fuel cell (or proton exchange membrane fuel cell) (PEMFC), which has been studied most extensively as a power source for driving vehicles. The fuel cell may include a cell stack 110.

The cell stack 110 may include a plurality of unit cells, which are stacked one above another in a first direction thereof. The number of unit cells may be determined depending on the intensity of the power which is to be generated in the fuel cell. The first direction may be a travel direction of the fuel cell vehicle 100 or may be a direction intersecting the travel direction of the fuel cell vehicle 100. The cell stack 110 generates a stack voltage and outputs the same to the load 140.

The converter 130 may be a type of DC-to-DC converter that converts a direct current-type (DC-type) input voltage into a DC-type output voltage having a level higher than the level of the DC-type input voltage. The converter 130 may boost a voltage of the battery 120 (hereinafter referred to as a “battery voltage”) and may output the boosted battery voltage to the load 140. For example, the converter 130 may boost the battery voltage to the level of the stack voltage.

The cell stack 110 is configured to generate main power necessary for the vehicle 100, and the battery 120 is configured to generate auxiliary power necessary for the vehicle 100. Therefore, energy stored in the battery 120 may be supplied as auxiliary power to the load 140.

The load 140 may include an inverter and a motor.

The inverter converts the DC-type voltage received from the cell stack 110 or the battery voltage boosted by the converter 130 into an alternating current-type (AC-type) voltage depending on the driving state of the vehicle 100, and outputs the converted AC-type voltage to the motor.

The motor may be driven in response to the AC-type voltage output from the inverter. That is, the motor may rotate upon receiving the AC voltage for the motor from the inverter, and thus may serve to drive the vehicle 100. For example, the motor may be a three-phase AC rotating device including a rotor in which a permanent magnet is embedded. However, the exemplary embodiments are not limited to any specific form of the motor.

Furthermore, although not shown, the load 140 of the vehicle 100 may include portions necessary to drive the vehicle, such as a motor-driven power steering (MDPS) device, a radiator fan, and headlights. The load 140 may be driven upon receiving the battery voltage boosted by the converter 120 or the stack voltage output from the cell stack 110 as a driving voltage.

The stack voltage and the battery voltage output from the two different power sources 110 and 120 have different levels, and the two power sources 110 and 120 have different discharge characteristics. Therefore, the converter 130 is provided to increase the level of the battery voltage to the level of the stack voltage. That is, the main voltage used to drive the load 140 is the stack voltage, and the converter 130 boosts the battery voltage, which includes a lower level than the stack voltage, to the level of the stack voltage and transmits the boosted battery voltage to the load 140.

The refresh unit 150 may adjust a voltage necessary to refresh the catalyst of the cell stack 110, i.e., to perform “catalyst refresh” (hereinafter referred to as a “refresh voltage”), depending on the charging state of the battery 120. To the present end, the refresh unit 150 may check whether the battery 120 is fully charged, i.e., whether the battery 120 is in a fully-charged state, and may adjust the refresh voltage in response to a result of the checking.

When the adjusted refresh voltage VF is used to refresh the cell stack 110, the refresh voltage VF may be supplied to the cell stack 110 from the refresh unit 150, as shown in FIG. 2. Alternatively, when the cell stack 110 is refreshed, the refresh unit 150 may be configured for controlling the cell stack 110 so that the level of the stack voltage becomes VF.

“Catalyst refresh” is a technology of temporarily lowering the level of a stack voltage of a fuel cell to remove an oxide film from a catalyst of a cell.

Hereinafter, the configuration and operation of the refresh unit 150 for refreshing the cell stack 110 in the vehicle 100 according to the exemplary embodiment of the present disclosure will be described.

FIG. 3 is a block diagram of an exemplary embodiment 150A of the refresh unit 150 shown in FIG. 2.

The refresh unit 150A may include a voltage calculation unit 152 and a voltage determination unit 154.

The voltage calculation unit 152 may be configured to determine an expected voltage Vb of the battery 120, which is expected when refreshing the cell stack 110, and may output the determined expected voltage Vb to the voltage determination unit 154.

According to the exemplary embodiment of the present disclosure, when determining the expected voltage Vb, the voltage calculation unit 152 may use an expected refresh power P of the cell stack 110 in which the degree of deterioration of the cell stack 110 is reflected. The expected refresh power P may be obtained experimentally or may be determined in real time.

Furthermore, the voltage calculation unit 152 may be configured to determine the expected voltage Vb using a zero-potential voltage Vo and a resistance value R corresponding to the state of charge (SOC) value of the battery 120. Here, the zero-potential voltage is a battery voltage when no current is drawn, and is determined depending on the SOC value of the battery. For example, the battery management unit 170 may check the SOC value of the battery 120 and may output a result of the checking to the voltage calculation unit 152 of the refresh unit 150.

The storage unit 160 shown in FIG. 2 may store the zero-potential voltage Vo and the resistance value R for each SOC value of the battery 120.

Table 1 below shows examples of the zero-potential voltage Vo and the resistance value R stored in the storage unit 160 for each SOC value of the battery.

TABLE 1
Specifications of Battery

| SoC [%] | Vo [Volt] | R [Ω] |
|---|---|---|
| 0 | 160 | 0.203 |
| 10 | 221 | 0.203 |
| 20 | 225 | 0.144 |
| 30 | 229 | 0.146 |
| 40 | 233 | 0.145 |
| 50 | 236 | 0.148 |
| 60 | 241 | 0.152 |
| 70 | 247 | 0.152 |
| 80 | 253 | 0.157 |
| 90 | 262 | 0.168 |
| 100 | 275 | 0.168 |

Here, SoC represents the state of charge of the battery 120.

The voltage calculation unit 152 may read the zero-potential voltage Vo and the resistance value R corresponding to the SOC value of the battery 120 from the storage unit 160 and may use the zero-potential voltage Vo and the resistance value R to determine the expected voltage Vb.

According to the exemplary embodiment of the present disclosure, the voltage calculation unit 152 may be configured to determine the expected voltage Vb using Equation 1 below.

$${V}_{b} = Vo - ( \frac{Vo - \sqrt{{Vo}^{2} - 4 \times R \times P}}{2 \times R} ) \times R \qquad [ Equation 1 ]$$

Equation 1 may be obtained as follows.

First, the expected refresh power P is expressed as in Equation 2 below.

$$P = {V}_{b} \times I \qquad [ Equation 2 ]$$

Here, I represents the current of the battery, and Vb may be expressed as in Equation 3 below.

$${V}_{b} = Vo - I \times R \qquad [ Equation 3 ]$$

Equation 4 below may be obtained by substituting Equation 3 into Equation 2 for the expected voltage Vb.

$$R \times {I}^{2} - Vo \times I + P = 0 \qquad [ Equation 4 ]$$

I in Equation 4 may be obtained using Equation 5 below.

$$I = \frac{Vo - \sqrt{{Vo}^{2} - 4 \times R \times P}}{2 \times R} \qquad [ Equation 5 ]$$

The above Equation 1 for Vb may be obtained by substituting the current I in Equation 4 into Equation 2.

Referring again to FIG. 2, the voltage determination unit 154 may compare a target voltage VT at which to refresh the cell stack 110 with the expected voltage Vb determined by the voltage calculation unit 152, and may be configured to determine the refresh voltage VF based on a result of the comparison.

The target voltage VT is a voltage at which the cell stack 110 is maximally refreshed, and may be determined in advance. That is, the target voltage VT is a voltage at which the oxide film removal effect is highest, and includes a fixed value. Therefore, it may be most ideal to perform refresh at the target voltage VT.

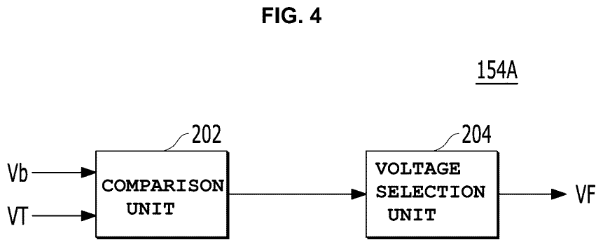

FIG. 4 is a block diagram of an exemplary embodiment 154A of the voltage determination unit 154 shown in FIG. 3.

The voltage determination unit 154 according to the exemplary embodiment of the present disclosure may include a comparison unit 202 and a voltage selection unit 204.

The comparison unit 202 compares the target voltage VT provided from the outside thereof with the expected voltage Vb determined by the voltage calculation unit 152 and outputs a result of the comparison to the voltage selection unit 204.

The voltage selection unit 204 may output the target voltage VT or the expected voltage Vb as the determined refresh voltage VF in response to the result of the comparison by the comparison unit 202.

In an exemplary embodiment of the present disclosure, the refresh unit 150 may include a processor to execute the voltage calculation unit 152 and the voltage determination unit 154.

Hereinafter, a method 300 of refreshing the fuel cell vehicle 100 according to an exemplary embodiment will be described with reference to the accompanying drawings.

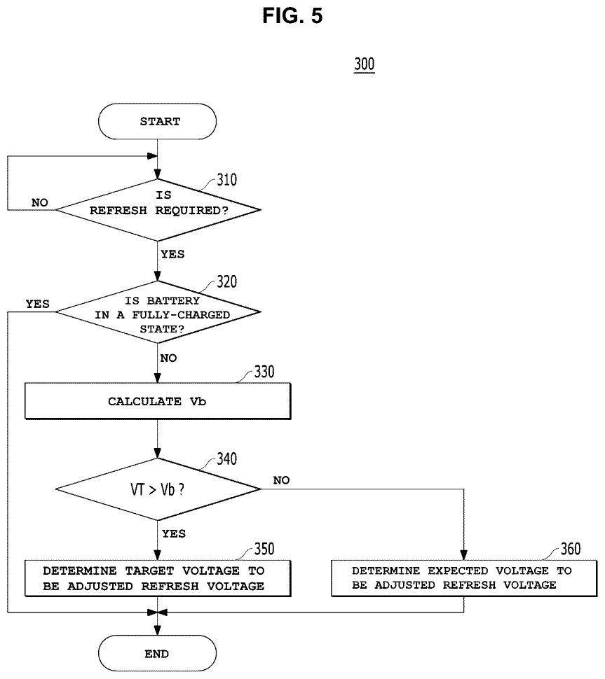

FIG. 5 is a flowchart for explaining the method 300 of refreshing the fuel cell vehicle 100 according to an exemplary embodiment of the present disclosure.

Hereinafter, the method 300 shown in FIG. 5 will be referred to as being performed by the refresh unit 150 shown in FIG. 3. However, the exemplary embodiments are not limited thereto. The method 300 shown in FIG. 5 may also be performed in a fuel cell vehicle including a configuration different from that shown in FIG. 3.

First, whether refresh of the cell stack 110 is required is checked (step 310).

If refresh is required, whether the battery 120 is in a fully-charged state is checked (step 320). When the battery 120 is in a fully-charged state, the method 300 shown in FIG. 5 is terminated.

If the battery 120 is not in a fully-charged state, the refresh voltage at which to refresh the catalyst of the cell stack 110 is adjusted depending on the SOC value of the battery 120 (steps 330 to 360).

In detail, when refresh of the cell stack 110 is required, the expected voltage Vb of the battery 120 expected when refreshing the cell stack 110 is determined (step 330). Step 330 may be performed by the voltage calculation unit 152 shown in FIG. 3. For example, the expected voltage Vb may be determined as in Equation 1 above.

After step 330, whether the target voltage VT at which to refresh the cell stack 110 is higher than the determined expected voltage Vb is checked (step 340). Step 340 may be performed by the comparison unit 202 shown in FIG. 4.

If the target voltage VT is higher than the expected voltage Vb, the target voltage VT is determined to be the adjusted refresh voltage VF (step 350). That is, when the level of the target voltage VT is greater than the level of the expected voltage Vb, the level of the stack voltage and the level of the battery voltage will not overlap each other when refresh is performed. Accordingly, the target voltage VT may be determined to be the final refresh voltage VF.

If the target voltage VT is lower than the expected voltage Vb, the expected voltage Vb is determined to be the adjusted refresh voltage VF (step 360). That is, when the level of the target voltage VT is less than the level of the expected voltage Vb, the level of the stack voltage and the level of the battery voltage may overlap each other when refresh is performed. Accordingly, the expected voltage Vb may be determined to be the final refresh voltage VF.

If the target voltage VT is equal to the expected voltage Vb, step 350 or step 360 may be performed.

The adjusted final refresh voltage VF may be adjusted between the target voltage VT and the expected voltage Vb.

Steps 340 to 360 may be performed by the voltage selection unit 204 shown in FIG. 4.

Hereinafter, the fuel cell vehicle 100 and an example of the refresh method 300 performed in the vehicle 100 will be described with reference to the accompanying drawings.

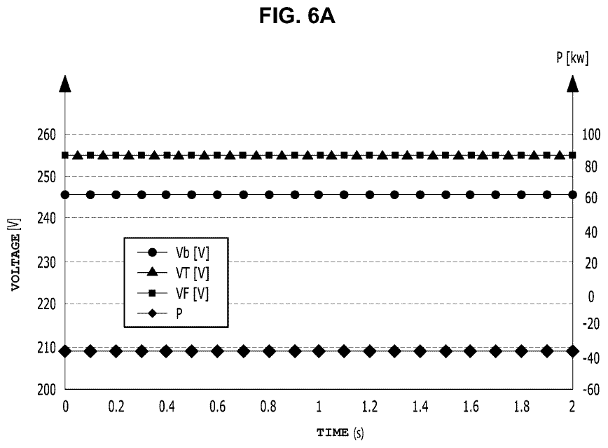

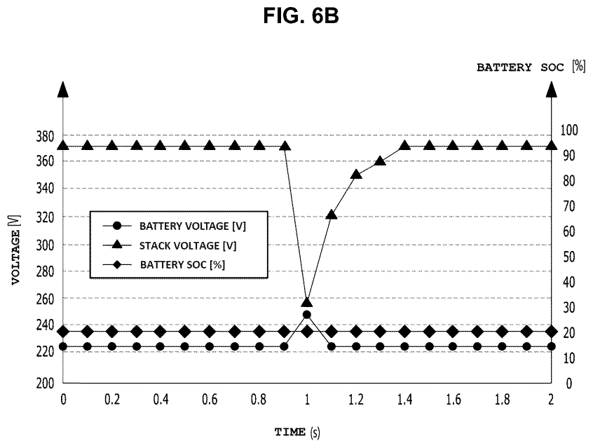

FIG. 6A and FIG. 6B are graphs for explaining a first application example of the refresh method 300 according to the exemplary embodiment of the present disclosure. In FIG. 6A, the horizontal axis indicates time, the left vertical axis indicates a voltage, and the right vertical axis indicates the expected refresh power P. In FIG. 6B, the horizontal axis indicates time, the left vertical axis indicates a voltage, and the right vertical axis indicates the state of charge (SOC) value of the battery 120.

According to the first application example, a beginning-of-life (BOL) cell stack 110 is used, the state of charge (SOC) value of the battery 120 is 20%, the expected refresh power P obtained in advance is 36 kW, and the target voltage VT is 255 volts. The expected refresh power P and the target voltage VT are provided from the outside thereof. In the instant case, it is assumed that the storage unit 160 stores the zero-potential voltage Vo and the resistance value R for each state of charge (SoC), as shown in Table 1.

Upon receiving, from the battery management unit 170, information that the state of charge (SOC) value of the battery 120 is 20%, the voltage calculation unit 152 of the refresh unit 150 reads the zero-potential voltage Vo of 225 volts and the resistance value R of 0.144 (from the storage unit 160 (refer to Table 1).

Subsequently, the voltage calculation unit 152 substitutes the zero-potential voltage Vo of 225 volts, the expected refresh power P of 36 KW (substituting −36,000 into Equation 1), and the resistance value R of 0.144Ω into Equation 1, obtaining the expected voltage Vb of 246 volts.

Subsequently, because the expected voltage Vb of 246 volts is lower than the target voltage VT of 255 volts, the voltage determination unit 154 predicts that the target voltage VT and the expected voltage Vb will not overlap each other, and thus is configured to determine the target voltage VT of 255 volts to be the adjusted final refresh voltage VF.

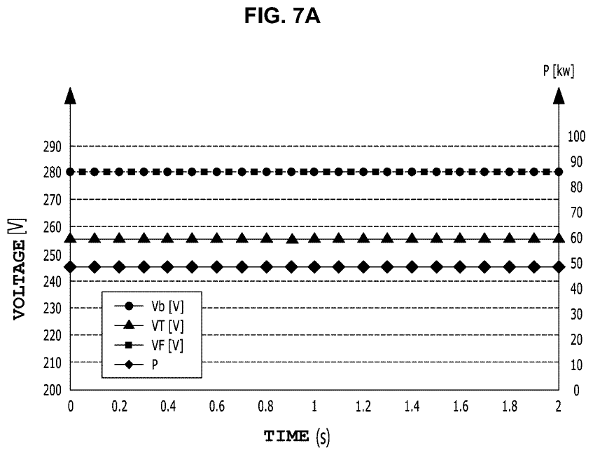

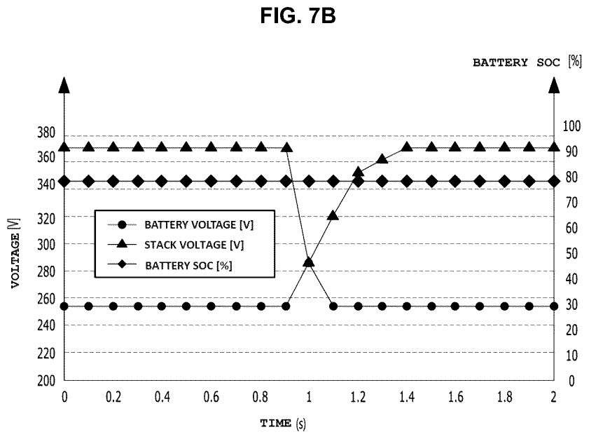

FIG. 7A and FIG. 7B are graphs for explaining a second application example of the refresh method 300 according to the exemplary embodiment of the present disclosure. In FIG. 7A, the horizontal axis indicates time, the left perpendicular axis indicates a voltage, and the right vertical axis indicates the expected refresh power P. In FIG. 7B, the horizontal axis indicates time, the left vertical axis indicates a voltage, and the right vertical axis indicates the state of charge (SOC) value of the battery 120.

According to the second application example, an end-of-life (EOL) cell stack 110 is used, the state of charge (SOC) value of the battery 120 is 80%, the expected refresh power P obtained in advance is 50 kW, and the target voltage VT is 255 volts, which is identical to that in the first application example. The expected refresh power P and the target voltage VT are provided from the outside thereof. In the instant case, it is assumed that the storage unit 160 stores the zero-potential voltage Vo and the resistance value R for each state of charge (SoC), as shown in Table 1.

Upon receiving, from the battery management unit 170, information that the state of charge (SOC) value of the battery 120 is 80%, the voltage calculation unit 152 of the refresh unit 150 reads the zero-potential voltage Vo of 253 volts and the resistance value R of 0.157Ω from the storage unit 160 (refer to Table 1).

Subsequently, the voltage calculation unit 152 substitutes the zero-potential voltage Vo of 253 volts, the expected refresh power P of 50 kW (substituting −50,000 into Equation 1), and the resistance value R of 0.157Ω into Equation 1, obtaining the expected voltage Vb of 280 volts.

Subsequently, because the expected voltage Vb of 280 volts is higher than the target voltage VT of 255 volts, the voltage determination unit 154 predicts that the target voltage VT and the expected voltage Vb will overlap each other when refresh is performed, and thus outputs the expected voltage Vb of 280 volts as the adjusted final refresh voltage VF. The expected voltage Vb of 280 volts corresponds to the smallest value, in so far as the stack voltage and the battery voltage do not overlap each other. The battery voltage and the stack voltage include the same magnitude, i.e., 280 volts. Because the refresh voltage VF (280 volts) in the second application example is higher than the refresh voltage VF (255 volts) in the first application example, the second application example includes a poor oxide film removal effect compared to the first application example. However, according to the second application example, damage to the hardware caused by overlap between the stack voltage and the battery voltage may be prevented, and the oxide film may be removed to the maximum extent.

The vehicle 100 according to the exemplary embodiment of the present disclosure may include various kinds of electronic control units (ECUs). Each of the ECUs is considered as a type of computer storing software for implementation of various functions for the vehicle 100. The refresh method 300 according to the above-described embodiment may be executed by the ECUs.

A recording medium in which a program for executing the refresh method performed in the fuel cell vehicle is recorded may store a program to implement a function of checking whether refresh of the catalyst of the cell stack 110 is required and a function of, when refresh is required, adjusting the refresh voltage at which to refresh the catalyst of the cell stack 110 depending on the state of charge of the battery 120. The recording medium may be read by a computer system.

Furthermore, the program stored in the computer-readable recording medium may further implement a function of, when refresh is required, checking whether the battery 120 is in a fully-charged state. When the battery 120 is not in a fully-charged state, the program may adjust the refresh voltage.

Furthermore, the function of adjusting may include a function of, when refresh is required, determining an expected voltage of the battery expected when refreshing the cell stack, a function of checking whether the target voltage at which to refresh the cell stack is higher than the determined expected voltage, a function of, when the target voltage is higher than the expected voltage, determining the target voltage to be an adjusted refresh voltage, and a function of, when the target voltage is lower than the expected voltage, determining the expected voltage to be an adjusted refresh voltage.

The computer-readable recording medium includes all kinds of storage devices in which data which may be read by a computer system is stored. Examples of the computer-readable recording medium may include ROM, RAM, CD-ROM, a magnetic tape, a floppy disk, and an optical data storage device. The computer-readable recording medium may also be distributed over network-coupled computer systems so that the computer-readable code is stored and executed in a distributed fashion. Also, functional programs, code, and code segments for accomplishing the above-described refresh method may be easily construed by programmers skilled in the art to which the present disclosure pertains.

Hereinafter, a fuel cell vehicle and a method of refreshing the same according to a comparative example and the fuel cell vehicle and the method of refreshing the same according to the exemplary embodiment of the present disclosure will be described.

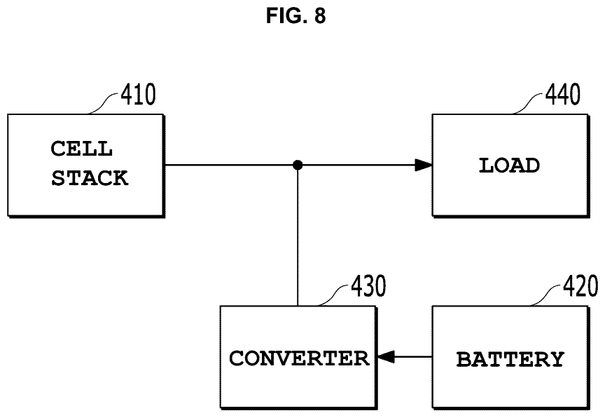

FIG. 8 is a block diagram of a fuel cell vehicle according to a comparative example.

The vehicle shown in FIG. 8 includes a cell stack 410, a battery 420, a converter 430, and a load 440. Because the cell stack 410, the battery 420, the converter 430, and the load 440 perform functions corresponding to those of the cell stack 110, the battery 120, the converter 130, and the load 140 according to the exemplary embodiment of the present disclosure, respectively, duplicate descriptions thereof will be omitted.

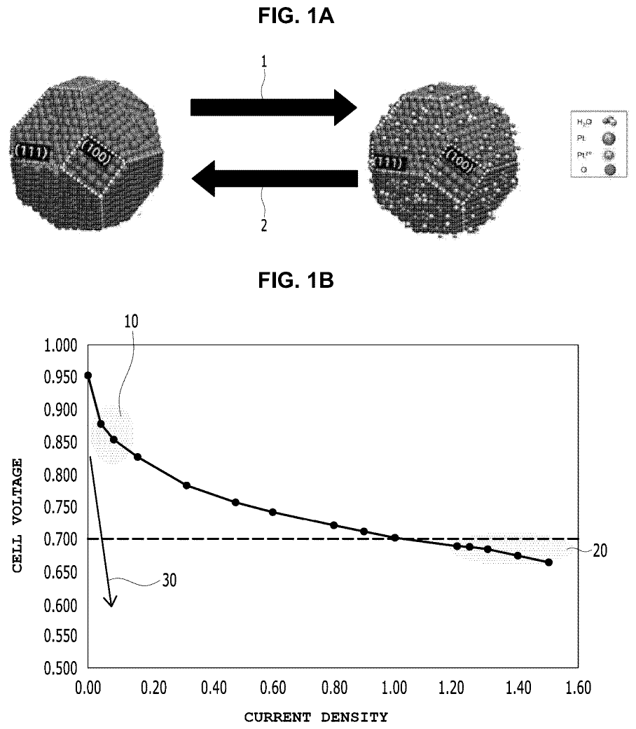

Unlike the fuel cell vehicle according to the exemplary embodiment of the present disclosure in FIG. 1, the fuel cell vehicle according to the comparative example in FIG. 8 does not include the refresh unit 150.

Because voltage boosting by the converter 430 is achieved only in one direction, the level of the battery voltage should be lower than the level of the stack voltage at all times. If not, the converter 430 may not operate. Elements located in the passage between the battery 420 and the cell stack 410 (e.g., elements in the converter 420) may be damaged due to the difference between the battery voltage and the stack voltage and uncontrollable current flow caused by physical resistance present in the passage between the battery 420 and the cell stack 410. If the vehicle utilizes two converters, such damage may be prevented. However, if only one converter is used, measures to prevent such damage are demanded.

If catalyst refresh is performed in a vehicle using only one converter 430, reversal may occur between the stack voltage and the battery voltage, which may cause greater damage to the hardware.

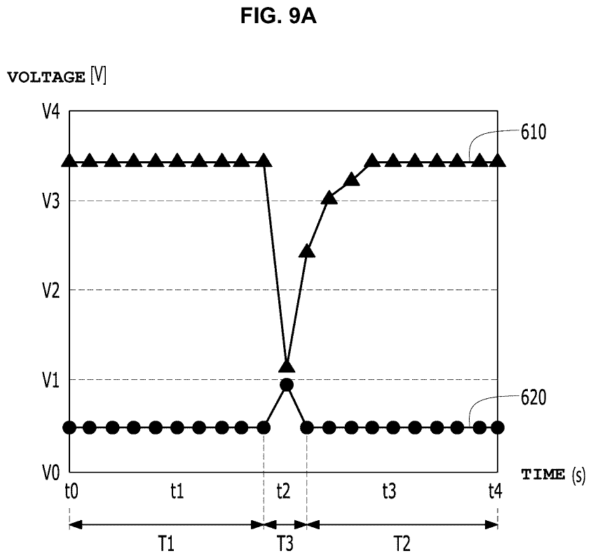

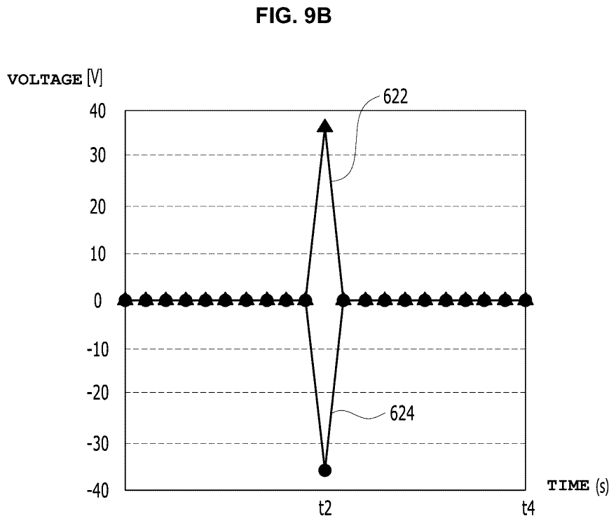

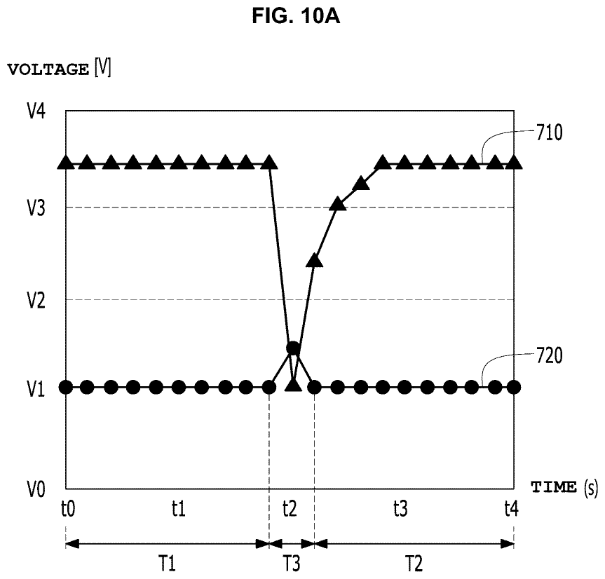

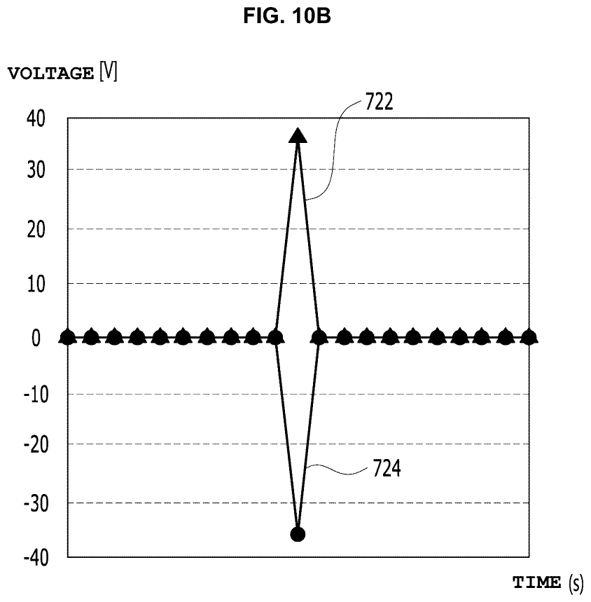

FIG. 9A and FIG. 9B are graphs showing the normal voltage and output characteristics of the fuel cell vehicle according to the comparative example, respectively, and FIG. 10A and FIG. 10B are graphs showing the abnormal voltage and output characteristics of the fuel cell vehicle according to the comparative example, respectively. In FIGS. 9A to 10B, the horizontal axis indicates time, the vertical axis indicates a voltage, reference numerals 610, 622, 710, and 722 represent the voltage and output of the cell stack 410, and reference numerals 620, 624, 720, and 724 represent the voltage and output of the battery 420. In FIGS. 9A and 10A, it is assumed that the vehicle is in a stationary state for a time period T1 from t0 to a predetermined time point before t2, that the vehicle is driven normally for a time period T2 from a predetermined time point after t2, and that refresh is performed for a time period T3 between T1 and T2.

The voltage of the battery 420 and the voltage of the cell stack 410 are lowered during discharge, and the voltages are lowered or increased together depending on load applied to the vehicle not only in the stationary state T1 but also in the usual situation T2 in which output changes. Therefore, the battery voltage and the stack voltage do not overlap each other. In the present way, the stack voltage and the battery voltage at the respective ends of the non-insulation-type converter 430 should be separated from each other.

However, in the situation T3 in which catalyst refresh is performed, the level of the stack voltage is lowered momentarily (about 0.1 s), and the battery 420 is charged with the momentarily increased output of the cell stack 410. Therefore, the battery voltage may momentarily increase to a peak. In the instant case T3, if the state of charge of the battery 420 is low, the stack voltage 610 and the battery voltage 620 do not overlap each other, as shown in FIG. 9A. In the instant case T3, however, if the state of charge of the battery 420 is high and the output of the cell stack is high when refresh is performed, the level of the battery voltage 720 may momentarily exceed the level of the stack voltage 710, and thus the stack voltage 710 and the battery voltage 720 may overlap each other, as shown in FIG. 10A. Accordingly, uncontrollable current may flow, causing damage to hardware.

For example, at the moment t2 of depressing the accelerator pedal of the vehicle, i.e., at the moment when demand output is generated, a voltage command is set to be low so that the cell stack 410 enters a low-potential state, removing the oxide film from the catalyst. Usually, when catalyst refresh is performed, the refresh voltage is fixed to the lower limit voltage of the fuel cell system set in consideration of driving voltages of auxiliary components, and thus the battery voltage and the stack voltage may overlap each other. If the refresh voltage itself is set conservatively high to avoid the present situation, the catalyst refresh effect may be reduced, and thus the oxide film may be insufficiently removed, making it impossible to obtain desired improvement in the performance of the stack.

In contrast, according to the exemplary embodiment of the present disclosure, the refresh voltage VF is not fixed but is adjusted in consideration of various factors (e.g., Vb) as well as the state of charge of the battery 120. Therefore, when refresh is performed, it is possible to prevent damage to the hardware (H/W) due to overlap between the battery voltage and the stack voltage and to perform catalyst refresh at as low a voltage as possible, removing the oxide film to the maximum extent and thus ensuring high performance of the stack.

The fuel cell vehicle 100 according to the above-described embodiment may be applied not only to vehicles but also to aircraft, ships, stationary power generation systems, and the like, without being limited thereto.

As is apparent from the above description, according to the fuel cell vehicle, the method of refreshing the same, and the recording medium storing a program to execute the method according to the embodiments, a refresh voltage is not fixed but is adjusted in consideration of various factors as well as the state of charge of a battery, whereby, when refresh is performed, it is possible to prevent damage to hardware due to overlap between a battery voltage and a stack voltage and to perform catalyst refresh at as low a voltage as possible, removing an oxide film to the maximum extent and thus ensuring high performance of a stack.

The effects achievable through the present disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

Furthermore, for any element or process which is not described in detail in any of the various exemplary embodiments of the present disclosure, reference may be made to the description of an element or a process including the same reference numeral in another exemplary embodiment of the present disclosure, unless otherwise predetermined.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fuel cell vehicle, comprising:
a battery;
a cell stack configured to generate and output a stack voltage;
a converter electrically connected to the battery and configured to boost a voltage of the battery;
a load configured to be driven by the stack voltage and the boosted voltage of the battery; and
a refresh unit configured to adjust a refresh voltage at which to refresh a catalyst of the cell stack depending on a state of charge (SOC) value of the battery.

2. The fuel cell vehicle of claim 1, wherein the refresh unit includes:
a voltage calculation unit configured to determine an expected voltage of the battery expected in refreshing the cell stack; and
a voltage determination unit configured to compare a target voltage at which to refresh the cell stack with the expected voltage and to determine the refresh voltage based on a result of the comparing.

3. The fuel cell vehicle of claim 2, wherein the cell stack is maximally refreshed at the target voltage.

4. The fuel cell vehicle of claim 2, wherein, in the determining of the expected voltage, the voltage calculation unit utilizes an expected refresh power of the cell stack in which a degree of deterioration of the cell stack is reflected.

5. The fuel cell vehicle of claim 4, wherein the expected refresh power is obtained experimentally or is determined in real time.

6. The fuel cell vehicle of claim 4, further including a storage unit configured to store a zero-potential voltage of the battery and a resistance value of the battery for each state of charge of the battery.

7. The fuel cell vehicle of claim 6, wherein the voltage calculation unit reads out a zero-potential voltage and a resistance value corresponding to the state of charge from the storage unit and utilizes the zero-potential voltage and the resistance value to determine the expected voltage.

8. The fuel cell vehicle of claim 7, wherein the voltage calculation unit is configured to determine the expected voltage as follows:
$${V}_{b} = Vo - ( \frac{Vo - \sqrt{{Vo}^{2} - 4 \times R \times P}}{2 \times R} ) \times R$$
where Vb represents the expected voltage, Vo represents the read zero-potential voltage, R represents the read resistance value, and P represents the expected refresh power.

9. The fuel cell vehicle of claim 2, wherein the voltage determination unit includes:
a comparison unit configured to compare the target voltage with the expected voltage; and
a voltage selection unit configured to output the target voltage or the expected voltage as the determined refresh voltage in response to a result of the comparing by the comparison unit.

10. The fuel cell vehicle of claim 9, wherein the voltage selection unit is further configured to output the target voltage as the determined refresh voltage in response that the target voltage is higher than the expected voltage, and to output the expected voltage as the determined refresh voltage in response that the target voltage is lower than the expected voltage.

11. The fuel cell vehicle of claim 1, wherein the refresh unit checks whether the battery is in a fully-charged state and adjusts the refresh voltage in response to a result of the checking.

12. The fuel cell vehicle of claim 1, further including a battery management unit configured to check the state of charge of the battery and to output a result of checking to the refresh unit.

13. A method of refreshing a fuel cell vehicle including a battery, a cell stack configured to generate and output a stack voltage, and a converter configured to boost a voltage of the battery, the method comprising:
checking, by a processor, whether refresh of a catalyst of the cell stack is required; and
upon concluding that the refresh is required, adjusting, by the processor, a refresh voltage at which to refresh the catalyst of the cell stack depending on a state of charge (SOC) value of the battery.

14. The method of claim 13, further including:
upon concluding that the refresh is required, checking, by the processor, whether the battery is in a fully-charged state,
wherein, upon concluding that the battery is not in a fully-charged state, the refresh voltage is adjusted.

15. The method of claim 13, wherein the adjusting includes:
upon concluding that the refresh is required, determining, by the processor, an expected voltage of the battery expected in refreshing the cell stack;
checking, by the processor, whether a target voltage at which to refresh the cell stack is higher than the determined expected voltage;
when the target voltage is higher than the expected voltage, determining, by the processor, the target voltage to be an adjusted refresh voltage; and
when the target voltage is lower than the expected voltage, determining, by the processor, the expected voltage to be an adjusted refresh voltage.

16. A non-transitory computer-readable recording medium storing a program for executing a method of refreshing a fuel cell vehicle including a battery, a cell stack configured to generate and output a stack voltage, and a converter configured to boost a voltage of the battery, the computer-readable recording medium storing a program to implement:
checking whether refresh of a catalyst of the cell stack is required; and
in response to the refresh is required, adjusting a refresh voltage at which to refresh the catalyst of the cell stack depending on a state of charge (SOC) value of the battery.

17. The non-transitory computer-readable recording medium of claim 16, wherein the program further implements:
in response that the refresh is required, checking whether the battery is in a fully-charged state, and
in response that the battery is not in a fully-charged state, the program adjusts the refresh voltage.

18. The non-transitory computer-readable recording medium of claim 16, wherein the function of adjusting includes:
in response that the refresh is required, determining an expected voltage of the battery expected in refreshing the cell stack;
checking whether a target voltage at which to refresh the cell stack is higher than the determined expected voltage;
in response that the target voltage is higher than the expected voltage, determining the target voltage to be an adjusted refresh voltage; and
in response that the target voltage is lower than the expected voltage, determining the expected voltage to be an adjusted refresh voltage.
